(19) United States
(12) Patent Application Publication
(10) Pub. No.: US 2005/0147727 A1
(43) Pub. Date: Jul. 7, 2005

(54) Snack food

(76) Inventor: Thomas C. Kozler, Livonia, MI (US)

Correspondence Address: L.C. BEGIN & ASSOCIATES, PLLC, 510 HIGHLAND AVENUE, PMB 403, MILFORD, MI, 48381, US

(21) Appl. No.: 11/028,251

(22) Filed: Jan. 3, 2005

Related U.S. Application Data
(60) Provisional application No. 60/534,033, filed on Jan. 2, 2004.

(51) Int. Cl. A23G 9/00

(52) U.S. Cl. 426/565

(57) ABSTRACT

New desert compositions are provided that include pudding, milk, an alcoholic beverage, and whipped topping. A method of forming the desert is also presented.

### CROSS-REFERENCE TO RELATED APPLICATIONS

The present application claims the benefit of U.S. Provisional Application Ser. No. 60/534,033 filed on Jan. 2, 2004.

### BACKGROUND OF THE INVENTION

A continuing challenge is to provide new and interesting deserts for general public consumption, and more particularly for adult consumption. Various party deserts have been produced in the past that contain alcohol and/or alcoholic beverages. For example, many candies have been made that include liqueurs, brandies, bourbons, and so on. Furthermore, “Jello™ shots” have been produced that provide an alcohol-based desert as a party favorite. One aspect of the deserts is the texture and palatability as the desert is consumed. Accordingly, it is an ongoing goal to improve the smoothness and texture of the desert thereby improving the overall taste and culinary experience.

### SUMMARY OF THE INVENTION

In accordance with the present invention, a composition formed from pudding mix, milk, an alcohol-based beverage, and whipped topping is provided. The constituents are mixed together to form a substantially uniform mixture, and then refrigerated to thicken the pudding.

### DETAILED DESCRIPTION OF THE INVENTION

In accordance with the present invention, a novel formulation and method of making the same are presented thereby offering a new party desert that may be enjoyed alone or in a party atmosphere. The present invention contemplates a first constituent made from any pudding available off the grocery shelf now or in the future. A second constituent includes milk, generally used when preparing pudding from powdered mixtures of pudding mix. Of course, a pre-prepared pudding already in thixotropic form may obviate the need for milk. A third constituent includes an alcohol-based product mixed with the other constituents. A fourth constituent includes whipping cream, or non-dairy whipped topping such as provided by Cool Whip™ made by Kraft Foods, or any other brand. As such, although the whipped topping or whipping cream may include dairy components, the whipped topping is preferably a non-dairy whipped topping as provided in the freezer section of any grocery store.

A first constituent may for example be selected from the group of puddings including, but not thereby limited, vanilla, white chocolate, regular chocolate, banana, lemon, cheesecake, coconut, butterscotch puddings, and other pudding types and mixtures thereof. The pudding may also be purchased at any grocery store, from manufacturers such as Dean's Pudding, Best Foods Pudding, Royal Pudding, and others exemplified at www.foodservicedirect.com.

A third constituent may be selected from any alcohol-based beverage or liquor suitable for human consumption. The alcohol-based constituent includes liqueurs, bourbons, whiskeys, rums, vodkas, brandies, and cognacs, for example, all provided by well known suppliers of each type of alcohol beverage. Liqueurs include beverages selected from the group including flavored and redistilled grain spirits, brandies, Irish whiskeys, gins, cognac, rum, and American whiskeys. Grain spirits may, for example, be flavored with aniseed, herbs such as dill and caraway seed, licorice, vanilla, anise, orange, Marula fruit and cream, roots, plants, peels, honey, coffee, ginseng, cherry, elderberries, and combinations thereof. Brandies may, for example, be flavored with almonds, apricots, orange, herbs, spices, orange peel, honey, coconut, and combinations thereof. Irish whiskeys, for example, may be flavored with blackcurrant, cream, herbs, fruit, roots, and combinations thereof. Gins, for example, may be flavored with herbs, botanical extracts, fruit extracts, and combinations thereof. Cognac, for example, may be flavored with herbs, honey, and combinations thereof. Rum, for example, may be flavored with aniseed, herbs, and combinations thereof. American whiskey, for example, may be flavored with peaches, orange, and combinations thereof. Liqueurs as described may be purchased from any liquor outlet or store from manufacturers such as Absinthe, Akvavit, Ouzo, Amaretto, Bailey's, Southern Comfort, B&B, Jagermeister, Goldschlager, Grand Marnier, Tia Maria, Triple Sec, Kahlua, Curacao, and many more.

Whiskeys such as American whiskey, Irish whiskey, and Canadian whiskey may be purchased from any liquor outlet or store, from manufacturers such as Jack Daniels, Seagram's, Canadian Club, Crown Royal, and so on.

Bourbons may be purchased from any liquor outlet or store, from manufacturers such as Wild Turkey, Maker's Mark, Jim Beam, and so on.

Rums may be purchased from any liquor outlet or store, from manufacturers such as Appleton, Bacardi, Captain Morgan, Malibu, Whalers, and so on.

Vodkas and flavored vodkas may be purchased from any liquor outlet or store, from manufacturers such as Absolut, Finlandia, Grey Goose, Smirnoff, Stolichnaya, and so on.

Cognacs may be purchased from any liquor outlet or store, from manufacturers such as Courvoisier, Hennessy, Remy Martin, Martell, and so on.

Brandies may be purchased from any liquor outlet or store, sold under the tradenames of Armagnac, Cognac, Grappa, Marc, Applejack, Calvados, Metaxa, Pisco, and Slivovitz and so on.

Schnapps, for example, may include peach, peppermint, watermelon, apple, pear, cranberry, cherry, vanilla, cinnamon, root beer, blackcurrant, butterscotch, melon, cactus, coffee, lemon, and others may be purchased from any liquor outlet or store, from manufacturers such as Mohawk, Godfrey's, Berentzen, Archers, and so on.

It should finally be noted that all of these liquors and others may also be available by mail order from www.beerliquors.com , for example.

More generally, Kahlua, triple sec, ouzo or other licorice flavored liquors, bourbons or whiskeys, regular and/or flavored vodka, Chambord, various flavors of liqueurs such as banana and other liqueur flavors, various flavors of schnapps such as peppermint, butterscotch, cinnamon, root beer, peach, watermelon and other flavors of schnapps, tequila, various flavors of rum such as Malibu rum and other flavors thereof, and any other alcohol-based ingredients that present a flavorful combination with the other constituents is contemplated as an alcohol constituent.

Optional constituents may include a fifth constituent selected from the group of syrup and extract flavorings including, but not thereby limited, orange extract, strawberry syrup and/or extract, cherry (or almond) extract, and other syrups and extracts. A sixth constituent may include foundational additives including graham cracker crumbs (used in the cheesecake varieties), cherry pie filling, coconut, margarita or other drink mixes, and other “heavier” additives correlating to the respective flavor of the pudding, all folded into the formulation.

The various constituents may be provided as desired to modify the consistency. However, it has been found that the following weight percents or “parts relationship” generally correspond to preferred consistencies or thicknesses of the ultimate desert. Accordingly, powdered pudding or pudding mix is preferably provided at about one to two parts of the total composition, or, at about 2-7 wt %. Milk is preferably provided at about four to eight parts of the total composition, or, at about 8 to 25 wt %. Alcohol is preferably provided at about fourteen to eighteen parts of the total composition, or, at about 27-55 wt %. Whipped topping is preferably provided at about eight to twelve parts of the total composition, or, at about 15 to 32 wt %. Optional fillers or “heavy” constituents such as pie filler, graham cracker crumbs, Margarita or other drink mixes are preferably provided at about one to fifteen parts, or, about 3-29 wt %. Optional flavorings and/or colorings may also be provided at about 1-10 wt %. All weight percents are given relative to the total compositional weight absent the flavorings and/or colorings. It should be noted that these are preferred percents and that other weight percents for each constituent are contemplated so long as the first four constituents of pudding, milk, alcohol beverage, and whipped topping are provided. In particular, the composition of these four main constituents should thicken to provide a pudding desert.

Servings or “shots” of pudding desert may be prepared by the following preferred process:
1. In a first bowl, empty a small package (one ounce) package of regular or sugar-free instant pudding mix. Different flavors as listed below may be employed, however, a preferred embodiment includes vanilla pudding (mixed with Kahlua and Vodka).
2. Instead of mixing with two cups of milk (or as otherwise directed by the box recipe), mix with ½ cup of milk and one cup of liquor.
3. Fold in whipping cream or Cool Whip™ and continue to fold/mix until a substantially homogeneous, creamy consistency or blend is formed. A standard 8 ounce size of whipped cream yields approximately 44 shots or servings. A larger 12 ounce size of whipped cream yields approximately 58 shots or servings. Hand mixing yields a fuller consistency thereby avoiding a liquid or runny consistency that may be formed if a power mixer is used. However, a power mixer such as a Hobart™ planetary mixer, used on a slow speed may be tailored to yield the desired fluffy or fuller consistency. Once completed, the mixture should preferably be a uniform mixture of constituents throughout its volume, or preferably substantially homogeneous.
4. Other constituents may likewise be added such as the various flavorings, colorings, syrups, extracts, or foundational ingredients including coconut or cherry pie filling. If graham crackers are desired with the cheesecake pudding for example, the crackers are best added to the top or center of the shot as it is placed into a container described below.
5. Each shot or serving approximates one ounce and is best accommodated by one ounce cups with lids. Accordingly, when the mixture is complete, fill the cups and cover them. Then place the shots in the refrigerator to firm up the consistency and thereby set the pudding. In essence, the mixture should be cooled by refrigeration or even by freezer to thicken the pudding, preferably to a thixotropic state. Accordingly, the desert is preferably served either refrigerated or frozen. The shots are now ready to be enjoyed. Alternatively, other serving vessels may be employed, or, vats of desert may be prepared and then refrigerated.
Different examples include the following mixtures with all four core constituents and then any flavorings or foundational constituents indicated:
1. Vanilla pudding combined with ½ cup of Kahlua and ½ cup of vodka;
2. White or regular chocolate pudding combined with ⅔ cup of chambord and ⅓ cup of vodka;
3. Banana pudding combined with ¾ cup of 99 proof bananas liqueur;
4. Lemon pudding combined with one cup of lemon vodka or regular vodka;
5. Vanilla pudding and ⅔ cup triple sec and ⅓ cup vodka and a couple of drops of orange extract, and orange food coloring;
6. Cheesecake pudding combined 14 ounces of pie filling, with ½ cup of strawberry syrup and a teaspoon of strawberry extract, and one cup of vodka; preferably place graham cracker crumbs in center or on top of the shot as the shot container is filled;
7. Cheesecake pudding combined with 14 ounces of cherry pie filling and a few drops of cherry or almond extract; preferably place graham cracker crumbs in center or on top of the shot as the shot container is filled;
8. Coconut cream pudding combined with one cup of Malibu rum;
9. Butterscotch pudding combined with ¾ cup of butterscotch schnapps and ¼ cup vodka;
10. White or regular chocolate pudding combined with ¾ cup of peppermint schnapps and ¼ cup of vodka;
11. Vanilla pudding combined with ¾ cup of root beer schnapps and ¼ cup of vodka;
12. Vanilla pudding combined with % cup margarita premix with tequila and ¼ cup of tequila;
13. Vanilla pudding combined with one cup of cinnamon schnapps; and
14. Vanilla pudding combined with one cup of ouzo.

It will be understood that the foregoing description of the present invention is for illustrative purposes only, and that the various formulations and combinations herein disclosed are susceptible to a number of modifications, none of which departs from the spirit and scope of the present invention. For example, the various amounts of each constituent are approximated in the method of mixing and in the examples given. It will be appreciated that the various constituents may be altered and/or varied in the respective amounts as given in the method of mixing described above, thereby tailoring the taste of each desert prepared.

1. A desert composition comprising:
pudding mix;
milk;
an alcoholic beverage; and
at least one selected from the group consisting of whipped topping, whipping cream, and mixtures thereof,
wherein each constituent is mixed with the others to form a mixture.

2. The composition of claim 1 wherein said pudding is selected from the group consisting of vanilla, white chocolate, chocolate, banana, lemon, cheesecake, coconut, butterscotch, pistachio, and mixtures thereof.

3. The composition of claim 1 wherein said alcoholic beverage is selected from the group consisting of liqueurs, bourbons, whiskeys, rums, vodkas, brandies, cognacs, and mixtures thereof.

4. The compositions of claim 1 further comprising a flavoring selected from syrups and extracts.

5. The composition of claim 4 wherein said flavoring is selected from the group consisting of orange extract, strawberry syrup, almond extract, and maple extract.

6. The composition of claim 1 further comprising a filler.

7. The composition of claim 6 wherein said filler is selected from the group consisting of graham cracker crumbs, pie fillings, drink mixes, and mixtures thereof.

8. The composition of claim 1 wherein said pudding is provided at about 2-7 wt %, said milk is provided at about 8 to 25 wt %, said alcoholic beverage is provided at about 27-55 wt %, and said whipped topping is provided at about 15-32 wt %.

9. The composition of claim 1 wherein said whipped topping is a nondairy or dairy topping.

10. The composition of claim 7 wherein said filler is provided at about 3-29 wt %.

11. A method of making a desert comprising the following steps:
provide a mixing bowl;
add about 2-7 wt % of pudding mix;
add about 6-25 wt % of milk, and slowly mix;
add about 26-55 wt % of an alcoholic beverage, and slowly mix;
add about 13-32 wt % of whipped topping, and slowly mix; and
refrigerate until the pudding thickens.

12. The method of claim 11 further comprising the step of adding a filler at about 3-29 wt % prior to the refrigeration step.

13. The method of claim 11 further comprising the step of adding a flavoring.

14. A desert formed by the method of claim 11.
